(19) United States
(12) Patent Application Publication
(10) Pub. No.: US 2006/0044789 A1
(43) Pub. Date: Mar. 2, 2006

(54) Post top receptacle adapter

(75) Inventor: Thomas Wayne Curtis, Monroe, GA (US)

Correspondence Address: TROUTMAN SANDERS LLP, 600 PEACHTREE STREET , NE, ATLANTA, GA, 30308, US

(73) Assignee: The Southern Company, a Delaware Corporation, Atlanta, GA (US)

(21) Appl. No.: 11/211,841

(22) Filed: Aug. 25, 2005

Related U.S. Application Data
(60) Provisional application No. 60/604,763, filed on Aug. 26, 2004.

(51) Int. Cl. F21S 8/00

(52) U.S. Cl. 362/152; 362/153.1

(57) ABSTRACT

A post top receptacle adapter is described. The post top receptacle adapter fits on a light pole between the pole and a light source. The adapter can include a fuse assembly to protect for overcurrent. Additionally, the adapter can include a sensor system. A switch can also be implemented on the adapter to allow switching on or off the power to the light fixture and the adapter.

### BACKGROUND OF THE INVENTION

1. Field of the Invention

The present invention generally relates to retrofit devices and, more particularly, to a retrofit device, which is located below an outdoor post top light fixture, providing a 120-volt receptacle, making the job of retrofitting easy and economical.

2. Description of Related Art

Many cities request utility companies to install 120-volt receptacles on their outdoor lighting poles for additional power supplies. Unfortunately, installing receptacles is expensive and dangerous. Even though special ordered poles are available to replace existing poles and are considerably less expensive, special ordered poles take much longer to obtain. Consequently, standard poles are installed, and the utility company must retrofit the pole with a receptacle.

Typically, the utility company attaches a weatherproof receptacle box to the exterior of the pole. This approach detracts from the aesthetics of the decorative features of the utility pole.

Additionally, many people have yards that have post top light poles as light sources. Many of these people prefer having a receptacle at the post top light pole to supply power. As a result, they rig a receptacle to the post by making a hole in the pole, tapping the power line, and attaching an outlet connector or receptacle to the pole. This is extremely dangerous and also takes away from the aesthetics of the decorative features of the pole.

Current methods of including receptacles with post top light sources include U.S. Pat. No. 3,251,047 to Smith. The Smith patent includes a decorative lamp post having a light source. The post includes a unitary power receptacle enabling attachment of a power cable. The power receptacle is mounted within the post of the lamp post.

Another method of implementing receptacles with post top light sources is described in U.S. Pat. No. 4,507,715 to Wedding. The Wedding patent describes a conventional electrical junction box with a conventional electric connector to receive an end of an electrical cable. The electrical cable can carry electrical current to the junction box. The electrical connector is connected to electrical wiring extending upwardly within a conduit to the light socket. The junction box is located near the bottom of the main body of the post.

Accordingly, the current methods require a unitary “pre-fabricated” type of device to implement a receptacle with a light source.

Thus, there is a need in the art for an improved post top receptacle adapter.

### SUMMARY

Often cities and counties request utility companies to install receptacles on post top outdoor light poles. As a result of the attaching the requested receptacles, the communities have access to power outlets for holiday and event lights, which can be temporarily powered by the receptacle. Typically, utility companies install and attach an external box to outside of the pole to house an outlet and the necessary receptacle connections. This approach is not cost effective and further detracts from the decorative features of the light pole. Unfortunately, special ordered poles take excessive time to construct and receive from manufacturers.

A retrofit device is described. The retrofit device can be a service unit. A pole is included to house and support the retrofit device. The pole has a top portion, a middle portion, and a bottom portion. Additionally, a light fixture is secured to the top portion of the pole. At least one receptacle is secured to the pole. The receptacle can have a fuse assembly adapted to protect the receptacle from overcurrent. Also, a switch is adapted to power on and power off to the light fixture and the receptacle. A sensor system is further enabled to de-energize and energize power.

The present invention includes the retrofit device having the post top receptacle adapter having a power outlet. The adapter can include the fuse assembly, so that if the fuse blows, it does not take the existing power out of service. The adapter can further include the switch, which can be a toggle or push-button, enabling a user to power on or off the adapter. The sensor system can be adapted to de-energize power during daylight.

The present invention also provides a method of installing a receptacle to a light pole. The retrofit device includes a light source and an adapter. The adapter, which has at least one receptacle attached, is a device that is installed between the light fixture and the pole. The adapter can be slideably secured to a tenon of the light pole. The adapter can be attached to the light pole with an attachment assembly, which can comprise a set of screws. The device has a receptacle and preferably a fuse assembly built into it. The device is easy, quick, and safe to install. In addition, the device does not detract from the aesthetics of the light pole.

The adapter can be attached to a tenon top pole. In addition to utilities using the present invention, individuals can add a receptacle to their own post top pole.

These and further objects, features, and advantages of the present invention will become more apparent upon reading the following specification in conjunction with the accompanying drawings.

### BRIEF DESCRIPTION OF THE DRAWINGS

FIG. 1 illustrates a perspective view of a retrofit device in accordance with an embodiment of the present invention.

FIG. 2 illustrates a perspective view of a post top light fixture and a pole in accordance with an embodiment of the present invention.

FIG. 3 depicts a perspective view of a receptacle device in accordance with an embodiment of the present invention.

FIG. 4 depicts a perspective view of the receptacle device in accordance with another embodiment of the present invention.

FIG. 5 illustrates a perspective view of a transmitter system and the pole in accordance with an embodiment of the present invention.

FIG. 6 illustrates a perspective view of a camera system and the pole in accordance with an embodiment of the present invention.

FIG. 7 depicts a perspective view of the camera system and the pole in accordance with an embodiment of the present invention.

FIG. 8 depiects a perspective view of an auxiliary device attached to the pole with a bracket in accordance with an embodiment of the present invention.

### DETAILED DESCRIPTION OF THE DRAWINGS

Referring now to the drawings, the invention will be described in more detail.

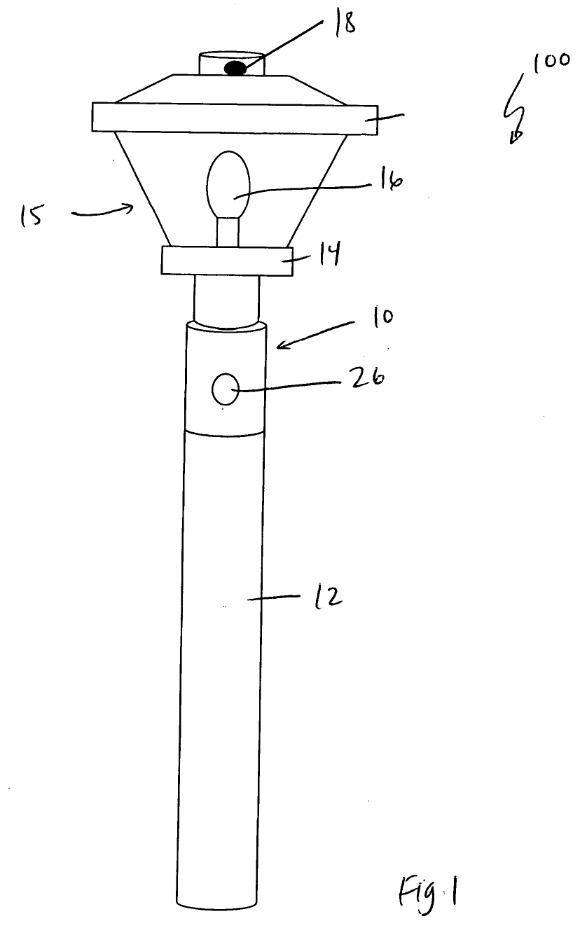

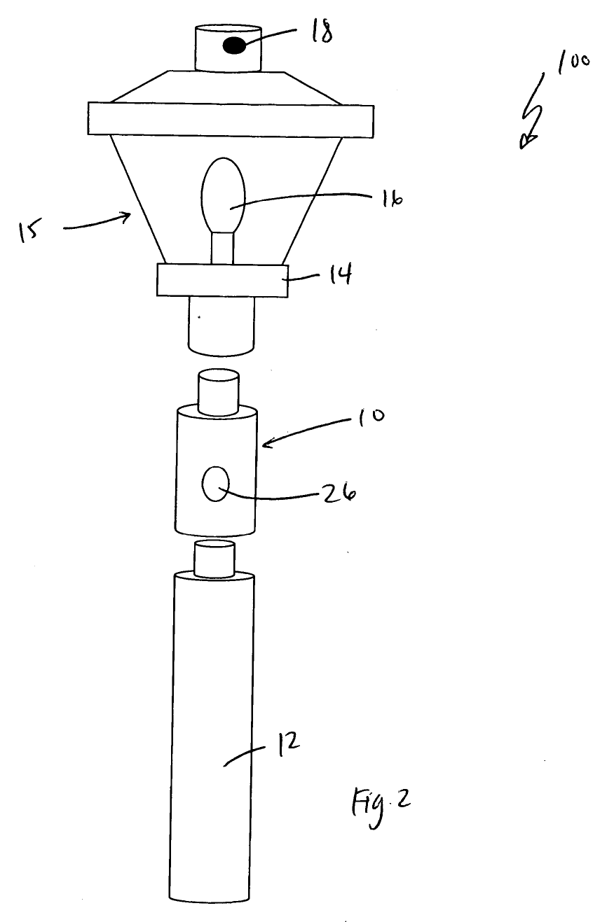

The present invention includes a retrofit device 100. The retrofit device 100 includes a post top receptacle adapter device 10. As depicted in FIGS. 1-2, the receptacle adapter device 10 can be located between a post top pole 12 and a post top light fixture 14 of the retrofit device 100. The post top light fixture 14 can generally include a lamp 15, having a light source 16, and a sensor system 18. The sensor system 18, in an exemplary embodiment, is a photo electric cell enabling automatic activation of the lamp 15.

The pole 12 can be manufactured from wood, concrete, fiberglass, metal, e.g. aluminum and steel, and the like. In an exemplary embodiment, the pole 12 is manufactured with wood with square cross-section. Additionally, in an exemplary embodiment, the wood can be laminated to protect the wood. The pole 12 can have a top portion, a middle portion, and a bottom portion.

The pole 12 has a hollow interior (not shown). The hollow interior permits a plurality of power wires or lines (not shown) to run therethrough. Typically, the post top pole 12 can range from 12 feet to 14 feet in height. Yet, as one skilled in the art can recognize, poles can run beyond that range, from 6 feet to 40 feet in some instances. The diameter or width of the pole 12 is substantially large enough to permit the wires to run through the pole 12 in order to reach the post top light fixture 14.

Poles 12 are implemented by directly burying the pole 12 in the soil or mounting the pole 12 on a concrete base (not shown). A direct buried pole is when the pole is placed into a hole, and the pole is mounted into the ground. Typically 4 to 6 feet of the pole is buried for the required stability. Alternatively, if a pre-cast concrete base is laid, the pole can be mounted atop the base. The base typically comes in 4 feet long and 8 feet long segments, and can be subsequently buried. The 4 foot base usually is buried to flush with ground level. The substantive weight of the concrete provides the necessary support for stability of the pole. Moreover, the concrete base can be poured into place, and vary the depth and height, according to the required anchor weight needed to properly support the pole.

Various national safety codes regulate the pole 12. For instance, the National Electric Safety Code (NESC) regulates the poles utilized by utilities. Poles utilized by all others are regulated by the National Electric Code (NEC). One difference between the two regulators is that the NESC usually requires aluminum wires to feed a lighting system, while the NEC usually requires copper wire.

The wires are fed into the bottom of the pole 12 to supply power to the retrofit device 100. The amount of current and voltage that the wire carries affects the depth that the wire must enter the pole 12. For instance, for wires with 600-volts or less, there is a minimum depth requirement of 24 inches. For wires carrying higher voltage, the minimum depth is 36 inches.

The pole 12 should be grounded for safety. Indeed, if the pole 12 is made of metal or concrete, the pole 12 must be grounded for safety. Typically, the grounding of a metal pole is performed by driving a ground rod at the metal pole. Conversely, concrete poles use a grounding lug where the ground wire is attached for safety. If the pole 12 is made of fiberglass or wood, however, the pole 12 is not required to be grounded.

The light source 16 of the lamp 15 can be normally between 100 watts and 250 watts. In some cases, however, the light source 16 can be as low as 50 watts and higher than 250 watts. The lamp 15 can be composed of many different light sources 16. One skilled in the art can appreciate that the light source 16 can be many types of light sources, including a light bulb, light emitting diode (LED), incandescent lamp, halogen lamp, fluorescent lamp, and the like. Additionally, the lamp 15 can be other types, such as sodium vapor, metal halide, and mercury vapor. Other devices or fixtures, such as directional flood lights, can be used atop the pole 12. These fixtures are often 1000 watts or less.

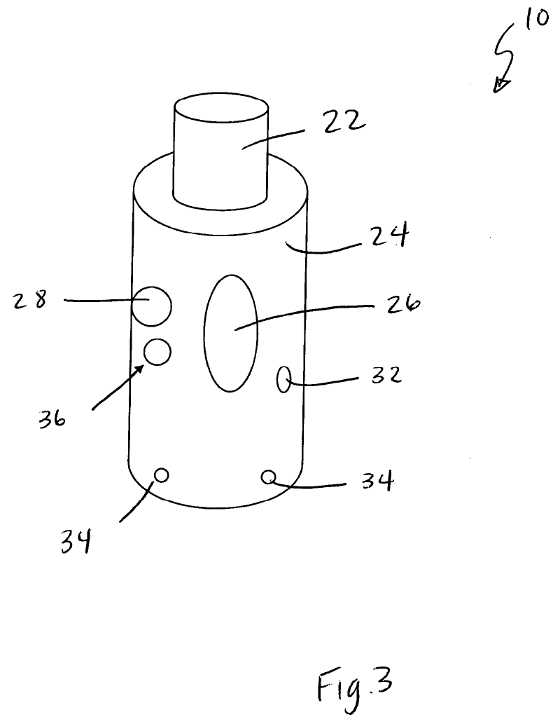

Referring to FIG. 3, the adapter 10 is shown in a close up view. The adapter 10 can include a tenon 22, a body portion 24, at least one weatherproof receptacle 26, a fuse assembly 28, a sensor system 32, an attachment assembly 34, and at least one weatherproof switch 36.

The tenon 22 is a projecting end of the pole 12 that is insertable into a hole, slot, groove or other recess into which another element can fit. The tenon 22 is adapted for insertion into a mortise of the adapter 10, enabling a snug fit. The tenon 22 is adapted to fit into the light fixture 14 in a similar manner. The tenon 22 is typically between two inches and four inches in diameter, and typically between three inches to six inches in length. The light fixture 14 comprises a diameter larger than the tenon 22 to receive the tenon 22. The tenon 22 can be secured to the light fixture 14 by a set of screws.

The body portion 24 can be made of aluminum or steel, wherein the outside of the body portion 24 can be comprised of a fiberglass resin-coat, or alternatively of metal. In an exemplary embodiment, the body portion 24 can be designed in a color and size to match the pole 12. In addition, the body portion 24 adapts to be molded into different shapes, adding decorative features to the retrofit device 100.

In addition, the body portion 24 can be weatherproof. This includes being waterproof and capable of withstanding varying temperatures. The weatherproof feature of the body portion 24 can be implemented by the user of rubber gaskets.

The length of the adapter 10 can vary. The length directly depends on the number and type of accessories incorporated into the adapter 10. Preferably, the length of the adapter 10 is between 9 inches and 12 inches. In an exemplary embodiment, there are a plurality of receptacles 26, enabling many power connections simultaneously.

The adapter 10 can be adapted to permit the permanent attachment of various devices, wherein power is provided to the devices via hard wire. Additionally, the adapter 10 can be adapted to include a permanent power supply, which can come through a small weather head, wherein the weather head is attached to the pole 12, which can help prevent possible NEC issues. The permanent power supply can enable the attachment of high technology equipment to the pole 10, as high technology equipment typically requires a permanent power supply.

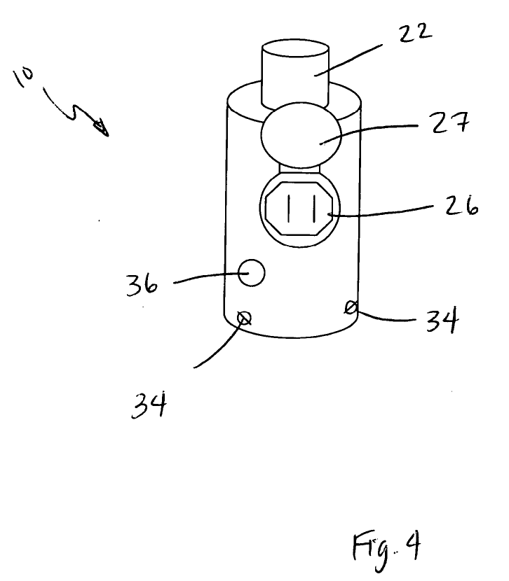

The receptacle 26 can be a single outlet. Alternatively, the receptacle 26 can comprise a plurality of electrical outlets. In an exemplary embodiment, the receptacle 26 includes two outlets. As depicted in FIG. 4, the receptacle 26 can be protected by a cover 27. The cover 27 can include a spring loaded mechanism enabling easy opening and closing of the cover 27; in addition, the cover 27 can include a seal. The receptacle 26 can further comprise ground fault interrupter (GFI) receptacles for added safety.

Referring back to FIG. 3, the fuse assembly 28 is also depicted. The fuse assembly 28 can be adapted to screw into the adapter 10. The fuse assembly 28 can be adapted to protect the lamp 15 and the receptacle 26 from possible overcurrent. The lamp 15, however, can include its own fuse, which can be located near the bottom of the pole 12. Additionally, the fuse assembly 28 can be included in the pole 12 for protection of event lighting, or auxiliary equipment, such as cameras, sensors, uninterruptible power supplies (ups), and the like. The fuse assembly 28 acts as a safety device, wherein as current increases to a predetermine level the fuse assembly 28 effectively cuts the flow of electrical current. A fuse implemented in the present invention can be 10 Amperes or less. Typically, the fuse should blow or disable before affecting the overcurrent protection of the utility cable, which is commonly approximately 30 Amperes.

Maintenance on the fuse assembly 28 is made easier by an externally accessible fuse. In the past, if a fuse blew it would knock out the entire system that supplies power to the pole. Thus, the utility company must send out a repair crew, including at least two linesmen, to repair the system. By the time the crew has completed their troubleshooting, the costs to repair have been extraordinary. The utility company must troubleshoot and repair the problem and the utility company will further lose revenue due to the loss of power to their customers. If the adapter 10 is equipped with the fuse assembly, the system could be operable more quickly.

The adapter 10 further includes the sensor system 32. The sensor system 32 can be adapted to turn the lamp 15 on at dusk, and off at sunrise; in an exemplary embodiment, this sensor system can comprise a photocell.

Indeed, the body portion 24 and the sensor system 32 can include a secondary photocell. This secondary photocell can be pre-wired to cut the existing light off, in the event that the community is using special lights, such as holiday lights. The secondary photocell acts to prevent burning of the lamp at the same time as supplying current to a special light, improving the effect of the special light.

The sensor system 32 can also improve electricity consumption. Since the sensor system 32 can be setup to turn power on and off at particular times, the sensor system 32 can eliminate waste of electricity. For instance, since the sensor system 32 can be adapted to turn the lamp 15 on at dusk, and off at sunrise, the sensor system 32 can effectively reduce the waste of electricity.

The attachment assembly 34 can be a device that attaches the adapter 10 to the tenon 22. In an exemplary embodiment, the attachment assembly 34 is a set of screws that can hold the adapter 10 onto the tenon 22. Preferably, the set of screws are composed of stainless steel or other material prohibiting rust. One skilled in the art will recognize that the attachment assembly 34 can be a conventional method of attaching the adapter 10 to the tenon 22.

At least one weatherproof switch 36 also is provided, wherein in an exemplary embodiment there are no more than three switches 36. The at most three switches can cut the existing post top lamp 15 out, another can cut on and off the sensor system 32, and yet another can cut the receptacle 26 on and off. As one skilled in the art will recognize, the switches 36 can be conventional existing switches, such as toggle switches, push-button switches, and the like.

The adapter 10 is a device that can be located on a post top pole 12, between the pole 12 and the post top light fixture 14. The adapter 10 enables an outlet or receptacle 26 to be included on the adapter 10. This is advantageous, as many communities request local utility companies to install receptacles on post top poles, therefore permitting attachment of event lights, holiday lights, and the like. The utility companies must cut an aperture in the existing pole and mount an outdoor outlet box into the pole. Naturally, as many of these poles are decorative poles, such conventional retrofitting destroy the aesthetics of the light pole, require a lot of labor, and are generally difficult to complete safely.

The present invention enables the utility company to remove the light fixture 14, install the adapter 10, and easily connect the wires to the adapter 10 and light fixture 14. The adapter 10 includes the receptacle 26. Additionally, the adapter 10 is further designed to not destroy the aesthetics of the pole 12 and is safe.

In the typical tenon top pole 12, the base of the adapter 10 is slightly larger in diameter than the pole 12, so the body portion 24 slips right over it, forming a snug fit. Preferably, the attachment assembly 36 can be used to tighten the body portion 24 to the pole 12. The post top light fixture 14 slips over the tenon 22 of the body portion 24 in a like manner.

In a retrofit embodiment, the post top light fixture 14 having the lamp 15 and the sensor system 32 is removed, and the post top receptacle body portion 24 is inserted on the top portion of the existing tenon 22.

The typical retrofit adapter 10 of the present invention is wired at 120 volts. The utility company must first visit the source of the power, which is often at a power transformer (not shown). The utility company must then de-energize the cable.

At least two wires (not shown), which are connected to the post top light source, slide into the bottom of the body portion 24. Next, these wires are tightened. Then, another set of two wires, which are pre-wired to the body portion 24, must be installed where the wires were originally removed from the light fixture 14. The body portion 24 can then slide onto the top portion of the pole 12, just as the light fixture 14 came off. Then, it will slide back on the same place, with the same attachment assembly. The light fixture 14 will fit back on the tenon 12 of the adapter 10, which will be almost identical to what it just came off of on the pole 12. The utility company must pull those two wires that are pre-wired into the adapter 10, up into the light fixture 14, and wire back just like the wires that came out of the pole 12. The adapter 10 is now secured to the pole 12.

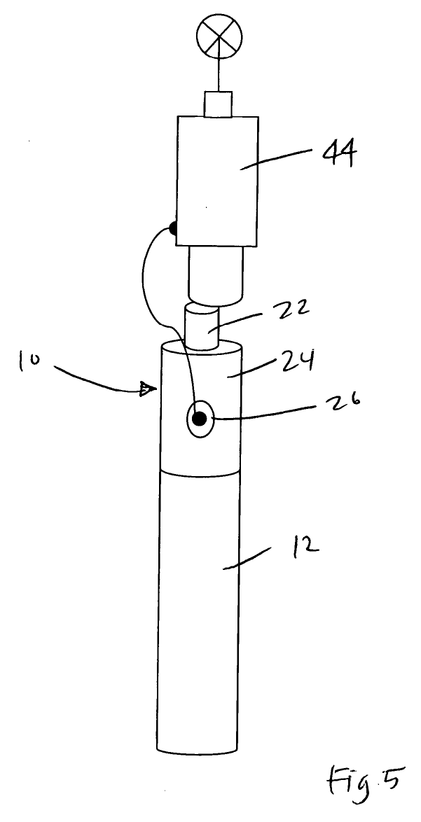

FIG. 5 depicts the adapter 10 located on the pole 12. The light fixture 14 can be included on the pole 12. A transmitter system 44 can also be included atop the pole 12. The transmitter system 44 can, for example, be a transmitter for a global positioning system (GPS) or cellular phone. The transmitter system 44 typically requires freedom of a 360 degrees rotation. Thus, the transmitter system 44, preferably, is placed atop the pole 12 for optimum performance. In addition, the transmitter system 44 will be plugged into the receptacle 26 of the adapter 10 attached to the pole 12.

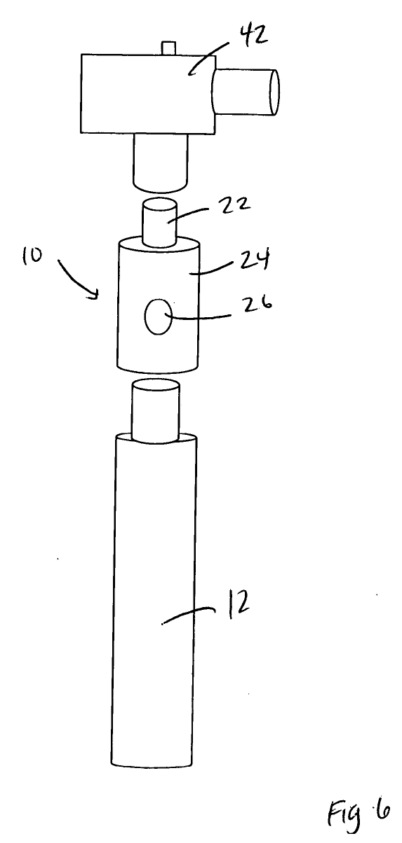

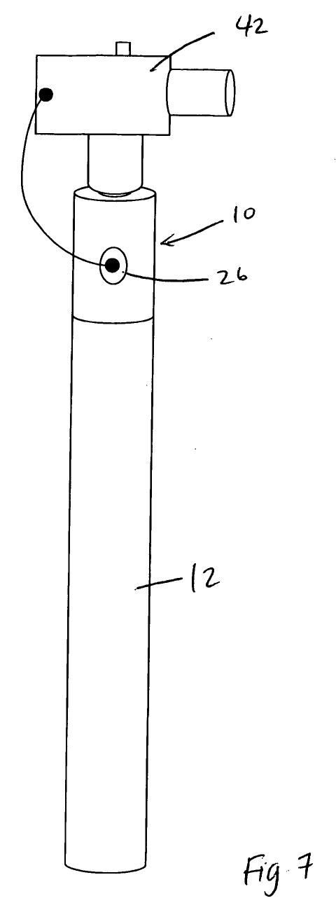

FIGS. 6-7 depict another embodiment of the present invention. In this exemplary embodiment, a camera system 42 can be installed atop the pole 12. Placing the camera system 42 atop the pole 12 allows the camera system 42 to pivot 360 degrees enabling a complete view around the pole 12. In an exemplary embodiment, the camera system 42 can be a security camera. In an exemplary embodiment including a security camera, the security camera can transmit wirelessly from their locations to a distant location. Indeed, the pole 12 located in parking lots are an ideal location for security cameras, or cameras for traffic control. Since these poles are typically larger than post top poles, being 35 feet to 45 feet in height, the adapter 10 can be located, the light removed and the camera wired through the pole 12.

The sensor system 32 can be installed on the pole 12, or specifically apart of the adapter 10, wherein the sensor system 32 detects motion. As a result of the sensor system 32 detecting motion, the camera system 42 can be activated. This design could reduce the cost of energy to supply the camera 42. In addition, the optional switch 36 can be used to de-energize the equipment for maintenance.

In fact, the adapter 10 is a convenient and ideal method of supplying power to camera system 42 or transmitter systems 44. One skilled in the art will appreciate that there are other systems or devices that can be attached to the pole 12 that require power that can use the receptacle 26 of the adapter 10. For instance, the pole 12 could include motion detectors, spy detectors, chemical detectors, smoke detectors, sirens, cell phone booster transmitters, warning devices, wind gauges, thermometers, weather devices, auxiliary devices, and the like that the adapter 10 can power via the receptacle 26. In addition, the optional fuse assembly 28 can provide overcurrent protection for the devices attached to the pole 12.

In addition to the exemplary pole 12 being used by utility companies, individuals owning poles in their own yards can implement the present invention into their post top poles. The adapter 10 would not take away from the aesthetics of the pole 12. Also, the receptacle 26 could be independently fused instead of being tied into the wiring controlling the lights. The fuse assembly 28 for this receptacle 26 protects the owner from overloading the circuit and de-energizing the pole.

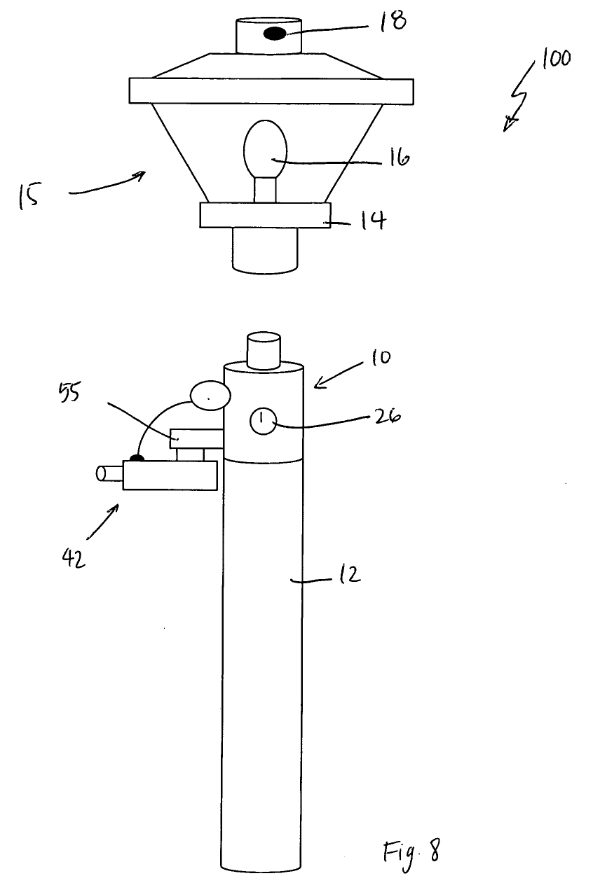

FIG. 8 depicts another embodiment of the present invention. A bracket 55 can be included in the top portion of the pole 12 for attaching devices, for example, the camera system 42 or the transmitter system 44. The bracket 55 can further enable mounting wireless devices, such as security cameras, and other technology equipment directly to the post top receptacle adapter 10.

The bracket 55 is connected to the adapter 10. The bracket 55 can have the ability to be rotated, shifted, or relocated, based on its intended use. The bracket can extend outwardly from the pole 12, in an exemplary embodiment. In another embodiment, the bracket 55 can extend outwardly, and also be set at an angle.

Although the present invention has been described with respect to particular embodiments, it will be apparent to those skilled in the art that modifications to the method of the present invention can be made which are within the scope and spirit of the present invention and its equivalents.

What is claimed is:

1. A retrofit device comprising:
a pole having a top portion, a middle portion, and a bottom portion, adapted to support the retrofit device;
a light fixture secured to the top portion of the pole;
at least one removable weatherproof receptacle secured to the pole via a tenon of the pole and including at least one power outlet; and
a fuse assembly adapted to protect the receptacle from overcurrent,

2. The retrofit device of claim 1, wherein the receptacle is slidably secured to the tenon with an attachment assembly.

3. The retrofit device of claim 1, wherein the receptacle is attached to the pole via an adapter.

4. The retrofit device of claim 1, wherein the receptacle further comprises ground fault interrupter receptacles enabling added protection.

5. The retrofit device of claim 1, wherein the receptacle has a cover to protect the power outlets.

6. The retrofit device of claim 1, wherein the fuse assembly is adapted to trip at less than ten amperes.

7. The retrofit device of claim 1, further comprising a sensor system adapted to de-energize and energize power.

8. The retrofit device of claim 7, wherein the sensor system comprises a photo sensor adapted to turn on power to the receptacle in the dark and turn off power to the receptacle in the light.

9. The retrofit device of claim 1, further comprising a camera system connected to the top portion of the pole.

10. The retrofit device of claim 9, wherein the camera system is attached to a mounting bracket connected to the top portion of the pole.

11. The retrofit device of claim 1, further comprising a cover adapted to protect the receptacle.

12. The retrofit device of claim 1, further comprising a transmitter system secured to the top portion of the pole.

13. The retrofit device of claim 1, further comprising a switch adapted to power on and power off the receptacle.

14. The retrofit device of claim 1, further comprising a permanent power supply.

15. A method of installing an adapter to a light pole having a light fixture and a plurality of power wires, the steps comprising:
removing the light fixture attached to the light pole;
disconnecting the power wires from the light pole;
connecting the power wires to the adapter;
securing the adapter to the light pole;
connecting the power wires from the adapter to the light fixture; and
attaching the light fixture to the light pole.

16. The method of claim 15, wherein the step of attaching the adapter to the light pole further comprises the step of sliding the adapter over a tenon of the light pole.

17. The method of claim 15, wherein the step of attaching the light fixture to the light pole further comprises the step of sliding the light fixture over a tenon of the adapter, wherein attaching the light fixture to the adapter which is attached to the light pole.

18. The method of claim 15, further comprising the step of de-energizing and energizing power to the light pole by a sensor system.

19. In a retrofit device comprising (i) a pole adapted to support the retrofit device, (ii) a light fixture secured to the pole, (iii) a fuse assembly to protect overcurrent in the retrofit device, wherein the improvement comprising a weatherproof receptacle retrofitted to be secured to the retrofit device via a tenon of the pole, wherein the receptacle includes a ground fault interrupter.

20. The improved retrofit device of claim 19, wherein the receptacle includes at least one power outlet enabling the attachment on the pole of auxiliary devices requiring power.
